(19) United States
(12) Patent Application Publication
(10) Pub. No.: US 2026/0330353 A1
(43) Pub. Date: Oct. 22, 2026

(54) SYSTEMS AND METHODS FOR INTERACTIVE CONSTRUCTION MANAGEMENT

(71) Applicant: ARDURRA GROUP, INC., Miami, FL (US)

(72) Inventor: Josh BEARSS, Maitland, FL (US)

(21) Appl. No.: 19/180,355

(22) Filed: Apr. 16, 2025

(51) Int. Cl. G06Q 10/0631

(52) U.S. Cl. CPC G06Q 10/06313

(57) ABSTRACT

Disclosed are systems and methods for digital delivery in construction management as an integrated workflow framework that transforms traditional paper-based processes into a comprehensive digital ecosystem. The framework incorporates multiple data acquisition sources, including aerial drone surveys and ground-based measurements, into a unified processing layer that generates dynamic three-dimensional models. Such models serve as primary deliverables between engineers and contractors, enabled by real-time visualization through augmented and virtual reality interfaces. The framework features progressive stage visualization capabilities, automated verification mechanisms utilizing computer vision, and direct interfaces with construction machinery for semi-automated operations. A hierarchical access control structure manages workflow progression while maintaining data integrity. The framework includes automated compliance verification, real-time progress monitoring, and comprehensive documentation capabilities, whereby such modular architecture enables scalability across various infrastructure project types while maintaining security protocols and improving overall project efficiency and reducing costs.

### FIELD OF THE DISCLOSURE

The present disclosure is generally related to digital construction management systems and methods, and more particularly, to a decision intelligence (DI)-based computerized framework that automatically and/or dynamically monitors, controls and manages stages, operations and the performance of equipment and human operators for construction projects, from inception to completion.

### SUMMARY OF THE DISCLOSURE

According to some embodiments, disclosed are systems and methods for a digital delivery and construction management framework that provides improved mechanisms for construction project management, such as, for example, in roadway construction. According to some embodiments, as discussed herein, the disclosed framework's operation can eliminate traditional paper-based workflows in favor of a comprehensive digital ecosystem. The disclosed framework builds upon the successful implementation of Building Information Management (BIM) systems in vertical construction, in that the framework can adapt and expand such principles for horizontal infrastructure projects. The fundamental shift moves away from conventional paper-based construction plans, specifications, and estimates, replacing them with an integrated digital workflow centered around a dynamic three-dimensional (3D) (and/or four-dimensional (4D)-3D plus time) model that serves as the primary deliverable between engineers and contractors.

According to some embodiments, the disclosed framework can operate via and/or based on data collection functionality, for which subsequent operations and management are based. For example modern drone-based surveying systems can serve as the primary data gathering mechanism, capturing detailed topographical information and current site conditions with unprecedented accuracy. Such data collection can also and/or alternatively include, but not be limited to, ground-based surveys, engineering inputs, regulatory requirements, budgetary constraints, material specifications, and the like. Accordingly, the disclosed framework can operate to aggregate such diverse data streams into a unified database, thereby creating a comprehensive digital representation of both existing conditions and proposed modifications. Such rich data environment enables more informed decision-making and helps identify potential issues before construction begins.

According to some embodiments, the disclosed framework can provide progressive visualization capabilities, which transforms how stakeholders interact with and understand project progression. For example, the framework can operate to break down construction phases into clearly defined stages, such as, for example, marked at 30%, 60%, 90%, and 100% completion. By way of a non-limiting example, according to some embodiments, at the 30% stage, stakeholders can visualize fundamental elements such as drainage ditches and basic earthwork. The 60% visualization incorporates base grade completion and initial structural elements. By 90%, the model shows completed pavement structures without final surface treatments or markings. And, the 100% view presents the finished project with all elements in place, including surface treatments, markings, and ancillary features. Such staged approach enables precise project tracking and enhanced quality control while facilitating better communication among all stakeholders.

In some embodiments, the disclosed implementation can utilize augmented reality (AR), virtual reality (VR) and/or extended reality (XR) technologies, which evidences an advancement in how construction teams interact with the project design. For example, field personnel can use mobile devices to view real-time overlays of planned construction elements against existing conditions, with precise positioning enabled through advanced geocoding. Such capabilities dramatically reduce interpretation errors and enable rapid verification of construction accuracy. As discussed herein, such immersive visualization tools also serve as powerful communication aids, allowing non-technical stakeholders to better understand project impacts and outcomes.

Accordingly, in some embodiments, the disclosed framework can implement verification mechanisms to ensure construction accuracy and compliance. For example, automated drone surveys can periodically capture construction progress, with, for example, computer vision algorithms comparing actual conditions against the design model. Such continuous feedback loop enables early detection of deviations from design specifications, allowing for rapid correction and reducing costly rework. The verification system extends beyond simple geometric compliance to include material specifications, construction methodologies, and regulatory requirements, creating a comprehensive quality assurance framework.

According to some embodiments, as discussed below, the framework can implement and/or control electronic safeguards that prevent progression to subsequent construction phases until all current phase requirements are met and verified. Such automated governance ensures proper sequence of construction activities and maintains quality control throughout the project lifecycle.

Thus, through standardized protocols, a digital model can be compiled and implemented in relation to and/or as part of equipment's operation to provide guidance and/or parameters to equipment control systems, enabling semi-automated or fully automated operations within defined constraints. Such capability extends to geofencing for equipment operation, automated grade control, and real-time position verification against the design model. The integration of machinery control systems not only improves construction accuracy but also enhances safety by preventing operations outside approved parameters.

Indeed, according to some embodiments, from a socioeconomic perspective, the framework offers substantial benefits across multiple dimensions. The reduction in paper-based workflows contributes to environmental sustainability while simultaneously improving information accessibility and reducing storage costs. Improved construction accuracy and reduced rework translate to more efficient use of materials and labor, contributing to project cost savings. Such enhanced visualization capabilities enable better public engagement during project planning phases, facilitating more informed community feedback and potentially reducing project opposition.

According to some embodiments, from a technical implementation perspective, the framework's modular architecture ensures scalability and adaptability to various infrastructure project types. Thus, while the discussion herein may focus on example embodiments of roadwork, for example, it should not be construed as limiting, as the framework's operation can be adapted to other types of infrastructure projects such as buildings, utilities, railways, airport facilities, and the like. Thus, one of skill in the art would recognize the instant disclosure's flexibility in maximizing the return on investment (ROI) in system development while providing a platform for continued innovation in construction management.

According to some embodiments, a method is disclosed for a digital construction management framework and operation of components related thereto. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a digital construction management framework and operation of components related thereto.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the disclosed systems and methods provide a comprehensive digital delivery system for construction project management that operates as a vertical and/or horizontal BIM platform. As discussed herein, the disclosed framework's modular architecture can function to create comprehensive digital documentation threads, streamlining regulatory compliance and supporting long-term asset management. Through its innovative combination of technologies into a cohesive, automated workflow, the disclosed framework's operations significantly reduces project risks and disputes while optimizing resource utilization and accelerating infrastructure development. The disclosed transformative, computerized solution addresses traditional construction management challenges while providing flexibility for future technological enhancements, thereby establishing a foundation for next-generation construction project management that addresses both technical and socioeconomic aspects of infrastructure development.

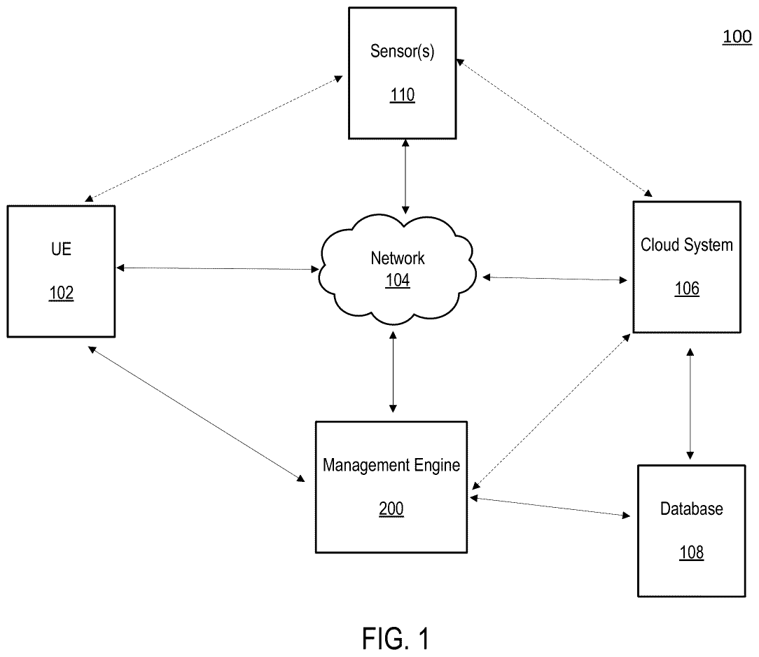

With reference to FIG. 1, a system is depicted for a construction (or location) 100 which includes user equipment (UE) 102, sensors 110, network 104, cloud system 106, database 108 and management engine 200. It should be understood that while system 100 is depicted as including such components, it should not be construed as limiting, as one of ordinary skill in the art would readily understand that varying numbers of UEs, sensors, cloud systems, databases and networks, inter alia, can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IOT) device, autonomous machine, and any other device equipped with a cellular or wireless or wired transceiver.

In some embodiments, UE 102 can be associated with and/or embodied as equipment for a construction project, which can include, but not be limited to, machinery and vehicles, tools and/or any other type of technology (e.g., construction management systems, BIM workstations, survey equipment, equipment tracking devices, quality control testing equipment, safety monitoring systems, time tracking systems, field tablets, and the like), and the like.

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 (and/or sensor 110) via any type of known or to be known pairing mechanism, including, but not limited to, Wi-Fi, Bluetooth™, Bluetooth Low Energy (BLE), NFC, and the like.

According to some embodiments, sensors 110 can correspond to sensors associated with a location of system 100 (e.g., a point/position within a construction site, for example). In some embodiments, sensors 110 can operate for collecting and/or monitoring data related to a construction project, which can include, but are not limited to, environmental sensors (e.g., temperature sensors, humidity sensors, air quality sensors, nose level sensors, weather stations, wind speed sensors, light level sensors, moisture sensors, and the like), structural and/or material sensors (e.g., strain gauges, crack meters, vibration sensors, tilt sensors, load cells, pressure sensors, concrete curing sensors, corrosion sensors, and the like), safety and security sensors (e.g., motions detectors, proximity sensors, wearable sensors, gas detectors, heat sensors, access control sensors, machine vision sensors, collision avoidance sensors, and the like), equipment and asset tracking sensors (e.g., GPS trackers, RFID tags, fuel level sensors, engine performance monitors, operating hours meters, maintenance condition sensors, equipment utilization sensors, battery life monitors, and the like), progress monitoring sensors (e.g., LIDAR scanners, photogrammetry sensors, 3D scanning equipment, thermal imaging cameras, ground penetrating radar, laser distance meters, reality capture devices, and the like), and the like, or some combination thereof.

In some embodiments, the sensors 110 can be, but are not limited to, thermistors, semiconductor based integrated circuits (IC), thermometers, and the like, for example) cameras, motion detectors, heat and smoke detectors, carbon monoxide (CO) and/or carbon dioxide (CO2) detectors, passive infrared (PIR) sensors, time-of-flight (ToF) sensors, and the like. In some embodiments, as discussed herein, the sensors 110 can involve an IoT environment and/or be associated with devices within a location's infrastructure, as discussed above.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a system provider (e.g., utility company, municipality, government agency, public works departments, private company, and the like, for example), which has associated network resources hosted on the internet or private network (e.g., network 104), which enables (via engine 200) the construction/project management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102 and the UE 102, sensors 110, and the services and applications provided by cloud system 106 and/or management engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

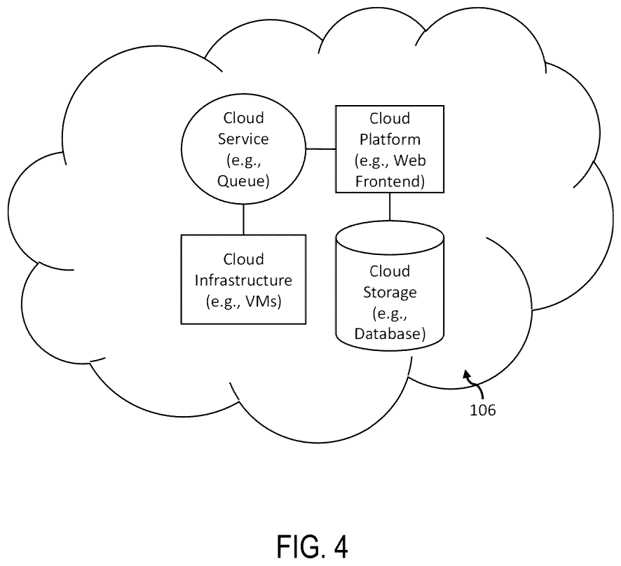

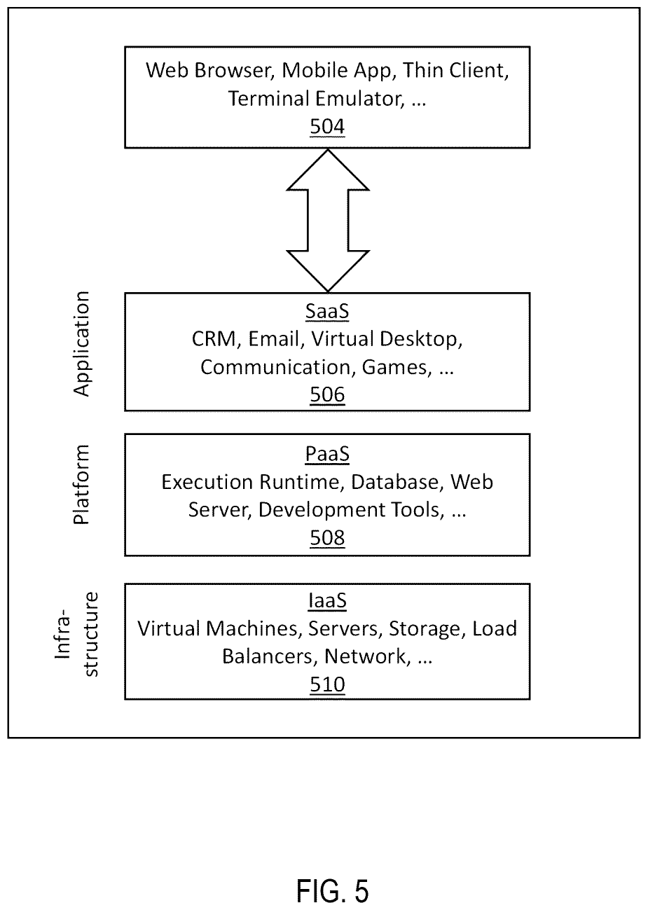

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 510, platform as a service (PaaS) 508, and/or software as a service (Saas) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 102 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, on UE 102 (and/or on sensors 110). In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed location (e.g., climate) management. Non-limiting embodiments of such workflows are provided below.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on sensors 110 and/or UE 102.

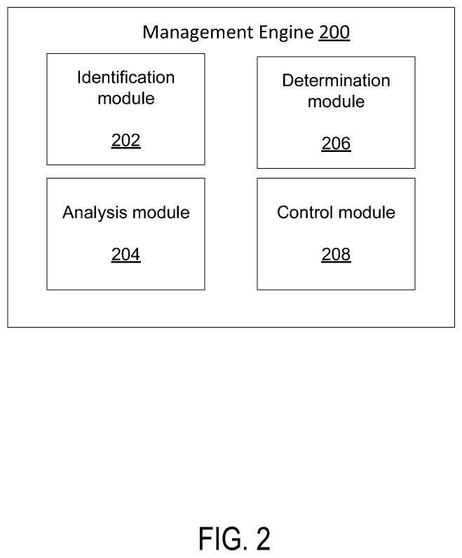

As illustrated in FIG. 2, according to some embodiments, management engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

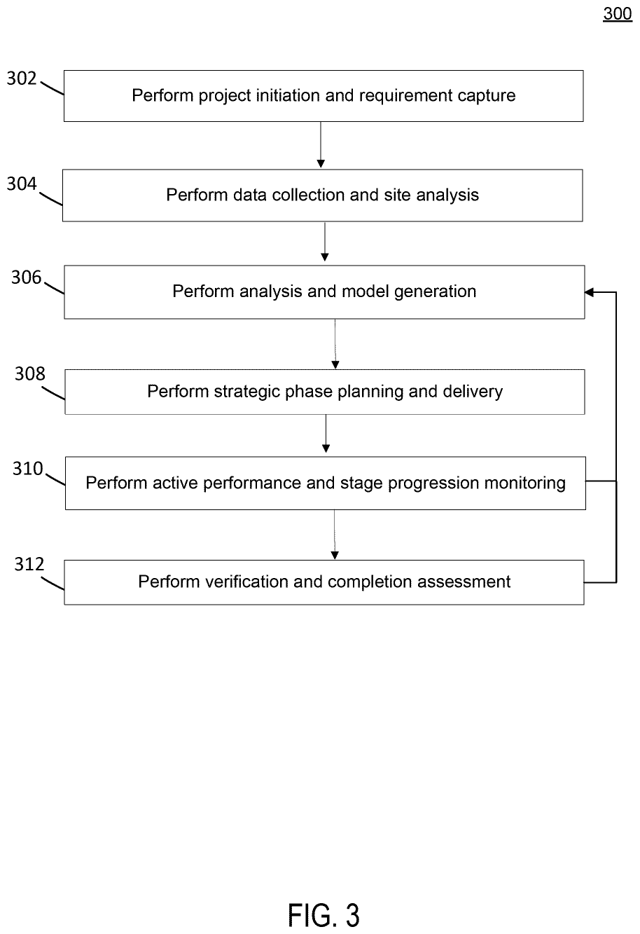

Turning to FIG. 3, Process 300 provides non-limiting example embodiments of the disclosed framework that provides features, capabilities and/or functionality for enhanced and/or improved construction project management and control for a cohesive project lifecycle, where each stage can build upon itself while maintaining data continuity and project integrity throughout the project's completion.

According to some embodiments, Steps 302 and 304 of Process 300 can be performed by identification module 202 of management engine 200; Step 306 can be performed by analysis module 204; Steps 308 and 310 can be performed by determination module 206; and Step 312 can be performed by control module 208.

According to some embodiments, Process 300 begins with Step 302 where engine 200 can receive and process project requests. Step 302 can involve comprehensive documentation of project requirements, scope definition, and preliminary constraint identification. In some embodiments, engine 200 can digitally capture stakeholder inputs, regulatory requirements, budgetary constraints, and environmental considerations. In some embodiments, Step 302 can involve engine 200 executing a large language model (LLM), for example, a natural language processing (NLP) model to analyze project documentation, and automatically extract key parameters, deadlines, and compliance requirements. In some embodiments, engine 200, as discussed herein, can create a digital project charter that serves as the foundation for subsequent stages, establishing baseline requirements and success criteria. During Step 302, engine 200 can initiate preliminary feasibility assessments, analyzing historical project data to identify potential challenges and optimization opportunities.

In Step 304, engine 200 can perform comprehensive data collection and site analysis. In some embodiments, Step 304 can involve the orchestration of a multi-faceted data collection process. In some embodiments, for example, automated drone surveys can capture detailed topographical information, while ground-based LiDAR systems provide high-resolution surface data. Accordingly, in some embodiments, for example, engine 200 can integrate existing infrastructure information from municipal databases, utility locations, soil conditions, and environmental factors along with the collected data. In some embodiments, engine 200 can incorporate and/or utilize real-time weather data and seasonal variations to ensure comprehensive site understanding. In some embodiments, Step 304 can involve the collection of regulatory compliance requirements, local building codes, and zoning restrictions.

Accordingly, in some embodiments, engine 200 can process the diverse data stream of collected data, discussed supra, through standardization algorithms, ensuring all information aligns with project coordinate systems and data standards. In some embodiments, engine 200 can utilize artificial intelligence/machine learning (AI/ML) algorithms, as discussed infra, to perform such analysis and/or identify potential data gaps or inconsistencies, triggering automated requests for additional information where necessary.

In Step 306, engine 200 can perform an intelligent analysis and model generation for the project. As discussed herein, engine 200 can process the collected data through multiple analytical layers to generate comprehensive project insights. In some embodiments, advanced AI/ML algorithms can be utilized to analyze historical project data alongside current site conditions to identify potential challenges and opportunities.

Accordingly, in some embodiments, engine 200 can implement any type of known or to be known computational analysis technique, algorithm, mechanism or technology to analyze the collected information from Step 304 (and Step 302, in some embodiments).

In some embodiments, engine 200 may include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the user data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, based on such analysis, engine 200 can generate a set (e.g., multiple) design scenarios, evaluating each against project requirements, budget constraints, and constructability factors.

In Step 306, based on the analysis, engine 200 can create project model (e.g., 3D model) that incorporates site constraints and project requirements. As discussed herein, the project model can be compiled and crated as an interactive 3D model that can be utilized to track real-world status/progress against a virtual status/progress for the project, which can be as a whole of the project and/or according to each stage/phase, as discussed infra. Accordingly, the project includes information related to, but not limited to, detailed cost modeling, resource allocation projections, construction sequence optimization, and the like. Engine 200 can utilize AI/ML models to assess various construction methodologies, whereby the compiled and created project model can represent a recommendation for an optimal approach(es) based on site conditions and project constraints. Step 306, in some embodiments, therefore, can involve the generation of a detailed digital twin that serves as the project's virtual backbone.

In Step 308, engine 200 can perform operations for strategic phase planning and delivery, which can be performed according to the model generated in Step 306, discussed supra. According to some embodiments, based on the comprehensive analysis discussed above, engine 200 can develop a detailed staging strategy that breaks the project into logical, achievable phases (or stage, used interchangeably). Each phase can be defined as a data structure within the project model, and can include information associated with specific deliverables, quality criteria, verification requirements, and the like.

Accordingly, in some embodiments, engine 200 can generate a detailed work package (or file structure or hierarchy within a created data structure for the project) for each stage, incorporating resource requirements, scheduling constraints, dependencies, and the like. Such staging strategy includes, but is not limited to, automated quality control checkpoints, which can define specific criteria that must be met before progression to subsequent phases.

In some embodiments, processing to a subsequent stage/phase is controlled based on verification of a current stage-thus, in some embodiments, if a current stage is not determined to be satisfied (e.g., the real-world progress does not match, at least to a threshold level, to the virtual progress within the stage of the project model, engine 200 will limit (e.g., read/write) access to such subsequent stage until it is completed).

In some embodiments, engine 200 can create a set of detailed visualization models for each stage (e.g., 30%, 60%, 90%, 100%), which can provide functionality for stakeholders to view and understand progression and requirements. In some embodiments, such processing can include the generation of machine control parameters for automated construction equipment and establishes verification protocols for each stage.

In Step 310, engine 200 can perform operations for active performance and stage processing monitoring and management. According to some embodiments, during construction, engine 200 can implement continuous (and/or periodic according to a criteria (e.g., time, location, type of activity, and the like)) monitoring protocols using a combination of technologies. For example, in some embodiments, automated drone surveys can provide regular progress updates. In another example, IoT sensors can monitor environmental conditions and construction parameters.

Accordingly, in some embodiments, engine 200 can track and compare actual progress against the digital twin using a AI/ML model(s) (e.g., computer vision algorithms), thereby identifying deviations in real-time (and/or according to a stage's scheduled progress, for example). Engine 200 can execute advanced analytics to process such information to generate progress reports, compliance verification, and quality assessments.

In some embodiments, engine 200 can maintain stage progression controls, which can require verification of all established criteria before allowing advancement to subsequent phases. In some embodiments, this can involve, for example, automated checks of material specifications, dimensional accuracy, construction methodology compliance and the like. Accordingly, in some embodiments, engine 200′s real-time monitoring can provide functionality and/or capabilities for immediate identification of potential issues, allowing for proactive problem resolution.

In some embodiments, as depicted in FIG. 3, a recursive operation from Step 310 to Step 306 can be utilized to move from a current stage to a next stage upon its verification. Upon completion of a final stage or penultimate stage, processing can proceed to Step 312.

And, in Step 312, engine 200 can perform operations for verification and completion assessments. According to some embodiments, engine 200 can implement and/or execute verification protocols to ensure project completion meets all established criteria. In some embodiments, engine 200 can utilize multiple verification mechanisms, including, but not limited to, automated geometric comparison against the digital twin, material property verification through non-destructive testing, comprehensive documentation review, and the like.

In some embodiments, engine 200 can utilize an AI/ML model(s) (e.g., computer vision algorithm(s), for example), as discussed above, to analyze as-built conditions against design specifications, generating detailed compliance reports. The system performs automated checks against all regulatory requirements and project specifications, ensuring all aspects of the work meet required standards.

Accordingly, Step 312 can involve the generation of comprehensive project documentation, including as-built models, maintenance requirements, warranty information, and the like. Engine 200 can maintain (e.g., in database 108, for example) a complete digital thread of all project decisions, changes, and verifications, providing a detailed audit trail for future reference.

In some embodiments, as discussed herein, throughout all stages, engine 200 can maintain robust cybersecurity protocols and access controls, ensuring data integrity and protecting sensitive project information.

Thus, as discussed herein, Process 300′s operation provides a comprehensive digital delivery system that provides advancements from traditional construction management approaches. The disclosed framework's ability to maintain data continuity while providing rigorous controls and verification mechanisms ensures consistent project delivery while minimizing risks and optimizing resources. The disclosed framework's adaptive nature allows for continuous improvement through AI/ML algorithms that analyze project outcomes and refine future recommendations. Accordingly, the disclosed structured approach to digital delivery provides significant advantages over traditional construction management methods, including improved accuracy, reduced rework, enhanced documentation and improved stakeholder communication. The framework's comprehensive functionality ensures that all aspects of project delivery are considered and properly managed, from initial concept through final verification and completion.

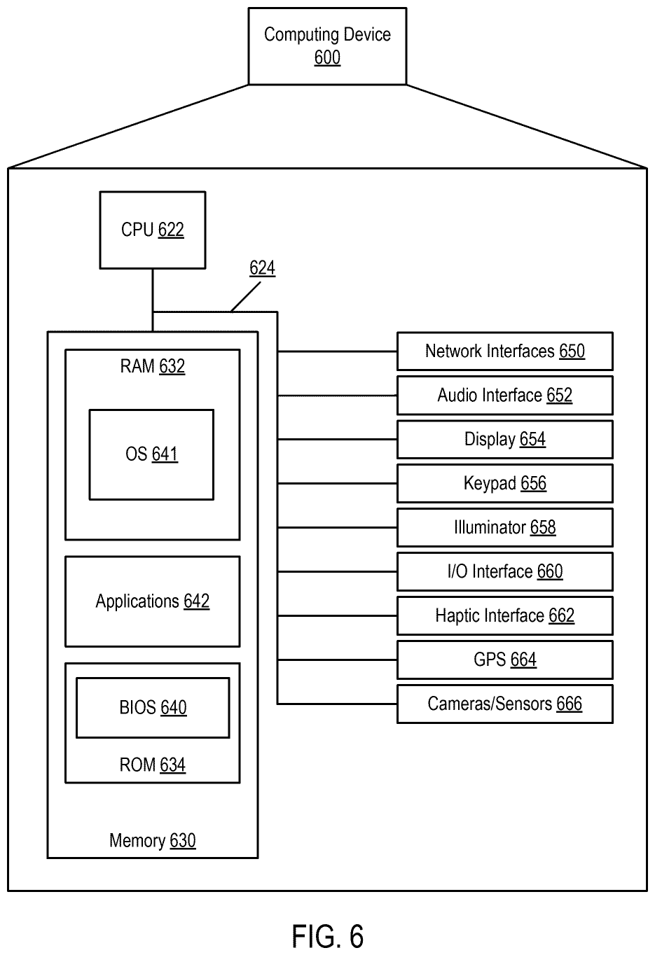

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™M, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   receiving, by an application a request for a project, the project corresponding to construction at a location, the request comprising information related to specifics of the project;
   analyzing, by the application, the request;
   generating, by the application, based on the analysis, a project model, the project model comprising information related to location constraints and project requirements, the project model being an interactive model that provides functionality for tracking real-world progress of the construction at the location against a virtual model according to the location constraints and project requirements;
   tracking, by the application, via the project model, the real-world progress of the construction at the location for the project; and
   controlling, by the application, the progress of the construction at the location via the tracking by the project model.
Aspect 2. The method of aspect 1, further comprising the project model being segmented according to a set of stages, each stage corresponding to a point of progress for the project.
Aspect 3. The method of aspect 2, further comprising:
   tracking, for an initial stage of the set of stages, real-world progress of the project that corresponds to the initial stage within the project model;
   determining a verification of completion of the second stage; and
   enabling a subsequent stage of the project based on the determined verification.
Aspect 4. The method of aspect 1, further comprising outputting, via the application, visualizations that enable a display of the tracked real-world progress against the project model's predicted progress.
Aspect 5. The method of aspect 1, further comprising:
   collecting additional project information related to the location, the additional project information generated and provided for the collection via another application or device; and
   performing the analysis of the request based further on the collected additional project information.
Aspect 6. The method of aspect 5, further comprising the additional project information further comprising compliance and regulatory requirements for the location.
Aspect 7. The method of aspect 1, further comprising:
   storing, in a database, an audit trail for the real-world progress; and
   providing updates to a device of a stakeholder based on the audit trail.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; ×86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
receiving, by an application, a request for a project, the project corresponding to construction at a location, the request comprising information related to specifics of the project;
analyzing, by the application, the request;
generating, by the application, based on the analysis, a project model, the project model comprising information related to location constraints and project requirements, the project model being an interactive model that provides functionality for tracking real-world progress of the construction at the location against a virtual model according to the location constraints and project requirements;
tracking, by the application, via the project model, the real-world progress of the construction at the location for the project, the tracking comprising obtaining in real-time, by the application implementing automated monitoring of actual conditions of the construction, data representative of the real-world progress of the construction at the location;
comparing in real-time, using at least an artificial intelligence based model implementing a computer vision algorithm, the data representative of the real-world progress with additional data defining the virtual model;
identifying in real-time, by the application based on the comparing, whether there is at least one deviation in the data representative of the real-world progress with respect to the additional data defining the virtual model;
generating, by the application, progress reports using the data and the additional data; and
controlling, by the application, the real-world progress of the construction at the location based on the tracked project model and the generated progress reports, the control corresponding to at least one equipment at the location.

2. The method of claim 1, further comprising the project model being segmented according to a set of stages, each stage corresponding to a point of progress for the project.

3. The method of claim 2, further comprising:
tracking, for a first stage of the set of stages, real-world progress of the project that corresponds to the first stage within the project model;
determining a verification of completion of a second stage of the set of stages; and
enabling a subsequent stage of the project based on the determined verification.

4. The method of claim 1, further comprising outputting, via the application, visualizations that enable a display of the tracked real-world progress against predicted progress of the project model.

5. The method of claim 1, further comprising:
collecting additional project information related to the location, the additional project information generated and provided for the collection via another application or device; and
performing analysis of the request based further on the collected additional project information.

6. The method of claim 5, further comprising the additional project information further comprising compliance and regulatory requirements for the location.

7. The method of claim 1, further comprising:
storing, in a database, an audit trail for the real-world progress; and
providing updates to a device of a stakeholder based on the audit trail.

8. A system comprising:
a processor configured to:
receive, by an application, a request for a project, the project corresponding to construction at a location, the request comprising information related to specifics of the project;
analyze, by the application, the request;
generate, by the application, based on the analysis, a project model, the project model comprising information related to location constraints and project requirements, the project model being an interactive model that provides functionality for tracking real-world progress of the construction at the location against a virtual model according to the location constraints and project requirements;
track, by the application, via the project model, the real-world progress of the construction at the location for the project, the tracking including obtaining in real-time, by the application implementing automated monitoring of actual conditions of the construction, data representative of the real-world progress of the construction at the location;
compare in real-time, using at least an artificial intelligence based model implementing a computer vision algorithm, the data representative of the real-world progress with additional data defining the virtual model;
identify in real-time, by the application based on the comparing, whether there is at least one deviation in the data representative of the real-world progress with respect to the additional data defining the virtual model;
generate, by the application, progress reports using the data and the additional data; and
control, by the application, the real-world progress of the construction at the location based on the tracked project model and the generated progress reports, the control corresponding to at least one equipment at the location.

9. The system of claim 8, wherein the processor is further configured such that the project model is segmented according to a set of stages, each stage corresponding to a point of progress for the project.

10. The system of claim 9, wherein the processor is further configured to:
track, for a first stage of the set of stages, real-world progress of the project that corresponds to the first stage within the project model;
determine a verification of completion of a second stage of the set of stages; and
enable a subsequent stage of the project based on the determined verification.

11. The system of claim 8, wherein the processor is further configured to output, via the application, visualizations that enable a display of the tracked real-world progress against predicted progress of the project model.

12. The system of claim 8, wherein the processor is further configured to:
collect additional project information related to the location, the additional project information generated and provided for the collection via another application or device; and
perform analysis of the request based further on the collected additional project information.

13. The system of claim 12, wherein the processor is further configured such that the additional project information further comprises compliance and regulatory requirements for the location.

14. The system of claim 8, wherein the processor is further configured to:
store, in a database, an audit trail for the real-world progress; and
provide updates to a device of a stakeholder based on the audit trail.

15. A non-transitory computer-readable storage medium tangibly encoded with computer-executable instructions that when executed by a device, perform a method comprising:
receiving, by an application, a request for a project, the project corresponding to construction at a location, the request comprising information related to specifics of the project;
analyzing, by the application, the request;
generating, by the application, based on the analysis, a project model, the project model comprising information related to location constraints and project requirements, the project model being an interactive model that provides functionality for tracking real-world progress of the construction at the location against a virtual model according to the location constraints and project requirements;
tracking, by the application, via the project model, the real-world progress of the construction at the location for the project, the tracking including obtaining in real-time, by the application implementing automated monitoring of actual conditions of the construction, data representative of the real-world progress of the construction at the location;
comparing in real-time, using at least an artificial intelligence based model implementing a computer vision algorithm, the data representative of the real-world progress with additional data defining the virtual model;
identifying in real-time, by the application based on the comparing, whether there is at least one deviation in the data representative of the real-world progress with respect to the additional data defining the virtual model;
generating, by the application, progress reports using the data and the additional data; and
controlling, by the application, the real-world progress of the construction at the location based on the tracked project model and the generated progress reports, the control corresponding to at least one equipment at the location.

16. The non-transitory computer-readable storage medium of claim 15, further comprising the project model being segmented according to a set of stages, each stage corresponding to a point of progress for the project.

17. The non-transitory computer-readable storage medium of claim 16, further comprising:
tracking, for a first stage of the set of stages, real-world progress of the project that corresponds to the first stage within the project model;
determining a verification of completion of a second stage of the set of stages; and
enabling a subsequent stage of the project based on the determined verification.

18. The non-transitory computer-readable storage medium of claim 15, further comprising outputting, via the application, visualizations that enable a display of the tracked real-world progress against predicted progress of the project model.

19. The non-transitory computer-readable storage medium of claim 15, further comprising:
collecting additional project information related to the location, the additional project information generated and provided for the collection via another application or device; and
performing analysis of the request based further on the collected additional project information.

20. The non-transitory computer-readable storage medium of claim 19, further comprising the additional project information further comprising compliance and regulatory requirements for the location.
